(19) United States
(12) Patent Application Publication
(10) Pub. No.: US 2015/0234883 A1
(43) Pub. Date: Aug. 20, 2015

(54) METHOD AND SYSTEM FOR RETRIEVING REAL-TIME INFORMATION

(71) Applicant: Tencent Technology (Shenzhen) Company Limited, Shenzhen (CN)

(72) Inventor: Mengfan LI, Shenzhen (CN)

(21) Appl. No.: 14/702,344

(22) Filed: May 1, 2015

Related U.S. Application Data
(63) Continuation of application No. PCT/CN2013/080071, filed on Jul. 25, 2013.

(30) Foreign Application Priority Data
Nov. 5, 2012 (CN) 201210434732.2

(51) Int. Cl. G06F 17/30

(52) U.S. Cl. CPC G06F 17/30353; G06F 17/30507; G06F 17/30864; G06F 17/30622

(57) ABSTRACT

The present disclosure provides a real-time information retrieval method including: acquiring a retrieval keyword and a retrieval target time period in a real-time information retrieval request; identifying, among multiple inverted real-time data blocks, an inverted real-time data block corresponding to the retrieval target time period by using a timestamp skip list in a data inverted index associated with the inverted real-time data blocks; retrieving information from the inverted real-time data block corresponding to the retrieval target time period according to the retrieval keyword, to obtain a retrieval result of the real-time information retrieval request; and returning the retrieval result of the real-time information retrieval request to the requesting terminal. The present disclosure further provides a real-time information retrieval apparatus performing the real-time information retrieval method. The present disclosure implements fast real-time data retrieval, and a data distribution trend graph can be acquired in real time with reduced costs.

### RELATED APPLICATIONS

This patent application is a continuation application of PCT Patent Application No. PCT/CN2013/080071, entitled “INFORMATION ACQUISITION METHOD FOR REAL-TIME RETRIEVAL, AND REAL-TIME RETRIEVAL APPARATUS AND SERVER” filed on Jul. 25, 2013, which claims priority to Chinese Patent Application No. 201210434732.2, entitled “INFORMATION ACQUISITION METHOD FOR REAL-TIME RETRIEVAL, AND REAL-TIME RETRIEVAL APPARATUS AND SERVER” filed on Nov. 5, 2012, both of which are incorporated by reference in their entirety.

### FIELD OF THE TECHNOLOGY

The present application generally relates to the field of data retrieval, and in particular, to a real-time information retrieval method, and a real-time information retrieval apparatus and server.

### BACKGROUND OF THE DISCLOSURE

With the rapid development of information technologies, information that people acquire in life increases geometrically. How to help a user to acquire needed data from an enormous amount of information is the problem that a data retrieval technology needs to solve. Nowadays, the data retrieval technology has been widely used in various industries. By using an article retrieval application on Weibo as an example, when retrieving articles that include a related keyword, a user may also want to know statistical data about related articles, for example, the total number of related articles in history and a distribution trend of the number of articles in a period of time. In an existing technology, when related statistics are collected, generally, retrieval is performed in all databases according to a keyword, to obtain data in a corresponding period of time by means of filtering, thereby returning a retrieval result to the user. Because it needs an extremely large computing amount to obtain a data distribution trend graph, generally, a retrieval system separately performs offline retrieval in a database according to keywords when the retrieval system is idle, so as to generate corresponding data distribution trend graphs. A data distribution trend graph needed by the user can be returned to the user provided that a keyword requested by the user hits a related data distribution trend graph obtained in advance by the retrieval system. Therefore, real-time update cannot be implemented.

### SUMMARY

In view of this, according to a first aspect of the present disclosure, a real-time information retrieval method, and a real-time information retrieval apparatus and server are provided, so as to reduce computing complexity of real-time information retrieval.

The real-time information retrieval method includes:

acquiring a retrieval keyword and a retrieval target time period in a real-time information retrieval request;

identifying, among a plurality of inverted real-time data blocks, an inverted real-time data block corresponding to the retrieval target time period by using a timestamp skip list in a data inverted index associated with the plurality of inverted real-time data blocks;

retrieving information from the inverted real-time data block corresponding to the retrieval target time period according to the retrieval keyword, to obtain a retrieval result of the real-time information retrieval request; and

returning the retrieval result of the real-time information retrieval request to the requesting terminal.

According to a second aspect of the present disclosure, a real-time information retrieval apparatus is further provided. The apparatus includes a processor, memory and a program module group stored in the memory and executed by the processor, and the program module group further comprising:

a retrieval request acquisition module, configured to acquire a retrieval keyword and a retrieval target time period in a real-time information retrieval request;

an inverted index module, configured to identify, among a plurality of inverted real-time data blocks, an inverted real-time data block corresponding to the retrieval target time period by using a timestamp skip list in a data inverted index associated with the plurality of inverted real-time data blocks; and

a retrieval module, configured to retrieve information from the inverted real-time data block corresponding to the retrieval target time period according to the retrieval keyword, to obtain a retrieval result of the real-time information retrieval request and return the retrieval result of the real-time information retrieval request to the requesting terminal.

It can be known from the above technical solutions that, in the foregoing aspects of the present disclosure, by using a newly added timestamp skip list in a data inverted index, an inverted real-time data block corresponding to a retrieval target time period can be found quickly, so that fast real-time data retrieval can be implemented, and further, a data distribution trend graph can be acquired in real time with reduced costs.

### BRIEF DESCRIPTION OF THE DRAWINGS

To illustrate the technical solutions in the embodiments of the present application or in the existing technology more clearly, the following briefly introduces the accompanying drawings required for describing the embodiments or the existing technology. Apparently, the accompanying drawings in the following description show merely some embodiments of the present application, and persons of ordinary skill in the art may still derive other drawings from these accompanying drawings without creative efforts.

FIG. 1 is a schematic flowchart of a real-time information retrieval method according to a first embodiment of the present application;

FIG. 2 is a schematic flowchart of a real-time information retrieval method according to a second embodiment of the present application;

FIG. 3 is a schematic flowchart of a real-time information retrieval method according to a third embodiment of the present application; and

FIG. 4 is a schematic structural diagram of a real-time information retrieval apparatus according to an embodiment of the present application.

### DESCRIPTION OF EMBODIMENTS

The following describes embodiments of the present application in detail with reference to the accompanying drawings in the embodiments of the present application. Apparently, the described embodiments are only some of the embodiments of the present application rather than all of the embodiments. All other embodiments obtained by a person of ordinary skill in the art based on the embodiments of the present application without creative efforts shall fall within the protection scope of the present disclosure.

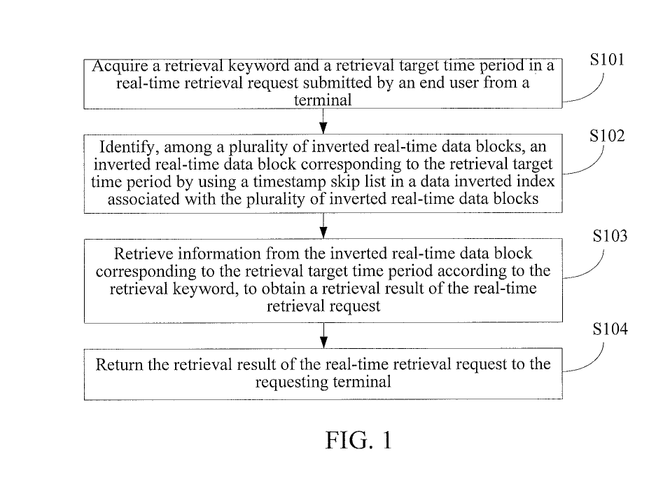

Referring to FIG. 1, FIG. 1 is a schematic flowchart of a real-time information retrieval method according to a first embodiment of the present application. The real-time information retrieval method includes the following steps:

S101: Acquire a retrieval keyword and a retrieval target time period in a real-time information retrieval request.

Specifically, the retrieval keyword may be a word input by a user, such as “beauty” or “Porsche”. The retrieval target time period includes a target start time and a target finish time of retrieval. The retrieval target time period may be input by the user or selected by the user from retrieval target time period options provided by a real-time information retrieval apparatus, or may be a default retrieval target time period of the real-time information retrieval apparatus, and indicates that the user wants to search for data related to the retrieval keyword within this time range. Optionally, before the step of acquiring a retrieval keyword and a retrieval target time period in a real-time information retrieval request, it may be determined whether the retrieval keyword in the real-time information retrieval request is an invalid keyword according to a preset logic judgment rule. Situations of determining that the retrieval keyword is an invalid keyword includes, but is not limited to the following:

1. a Chinese keyword longer than 20 Bytes or shorter than 4 Bytes;

2. a combined Chinese and non-Chinese keyword longer than 20 Bytes or shorter than 2 Bytes;

3. a keyword including a security sensitive word (for example, a pornographic or politically sensitive word); and

4. a keyword only including an ultra-high frequency word (such as “of” or “is”).

When it is determined that the retrieval keyword is an invalid keyword, a specific result may be returned to the user, for example, “something is wrong with the input keyword”, “the input keyword includes a sensitive word”, or “the keyword is invalid”; or if it is determined that the retrieval keyword is not an invalid keyword, the retrieval keyword and the retrieval target time period in the real-time information retrieval request are acquired.

S102: Identify, among a plurality of inverted real-time data blocks, an inverted real-time data block corresponding to the retrieval target time period by using a timestamp skip list in a data inverted index associated with the plurality of inverted real-time data blocks.

Specifically, the data inverted index in this embodiment of the present application includes a timestamp skip list, and the inverted real-time data block corresponding to the retrieval target time period may be found by using the timestamp skip list in the data inverted index. For example, when the retrieval target time period input by the user is three days ranging from September 21 to September 23, an inverted real-time data block corresponding to September 21 to September 23 may be found by using the timestamp skip list in the data inverted index. Further, optionally, the retrieval target time period may be first matched with a corresponding hierarchical database by using the timestamp skip list in the data inverted index, and then, the inverted real-time data block corresponding to the retrieval target time period may be acquired in the hierarchical database corresponding to the retrieval target time period. The hierarchical database may include multiple databases for separately storing inverted real-time data blocks in different time periods, for example, the hierarchical database may include a miniature cycle unit for storing data in the last three days; a small cycle unit for storing data from 10 days ago to 3 days ago, a medium cycle unit for storing data from 30 days ago to 10 days ago; and a large cycle unit for storing data before 30 days ago. The real-time information retrieval apparatus may find the corresponding hierarchical database by using the timestamp skip list in the data inverted index and according to the retrieval target time period, and then acquire, in the hierarchical database corresponding to the retrieval target time period, the inverted real-time data block corresponding to the retrieval target time period. For example, if the retrieval target time period in the request of the user is the last 8 days, the hierarchical database matching the retrieval target time period may include the miniature cycle unit and the small cycle unit. Further, the inverted real-time data block corresponding to the retrieval target time period may be directly searched for in the two relatively small hierarchical databases, so as to avoid search in a hierarchical database with a huge amount of data, thereby saving a lot of system resources.

S103: Retrieve information from the inverted real-time data block corresponding to the retrieval target time period according to the retrieval keyword, to obtain a retrieval result of the real-time information retrieval request.

Specifically, retrieval may be performed, according to the retrieval keyword, in the inverted real-time data block found in step S102, to find data including the retrieval keyword, and a retrieval result of the real-time information retrieval request is returned to the user. The result may include the found data, or may be a statistical result computed according to the found data. By using retrieval of articles on Weibo as an example, if the user wants to retrieve articles including a keyword “beauty” and posted in the last three days, a list of all articles including “beauty” and posted in the last three days may be returned to the user, and the total number of the articles including “beauty” and posted in the last three days, and the like may further be returned to the user.

S104: Return the retrieval result of the real-time information retrieval request to the requesting terminal.

Specifically, the retrieval result is organized in a format that can be visualized on the requesting terminal.

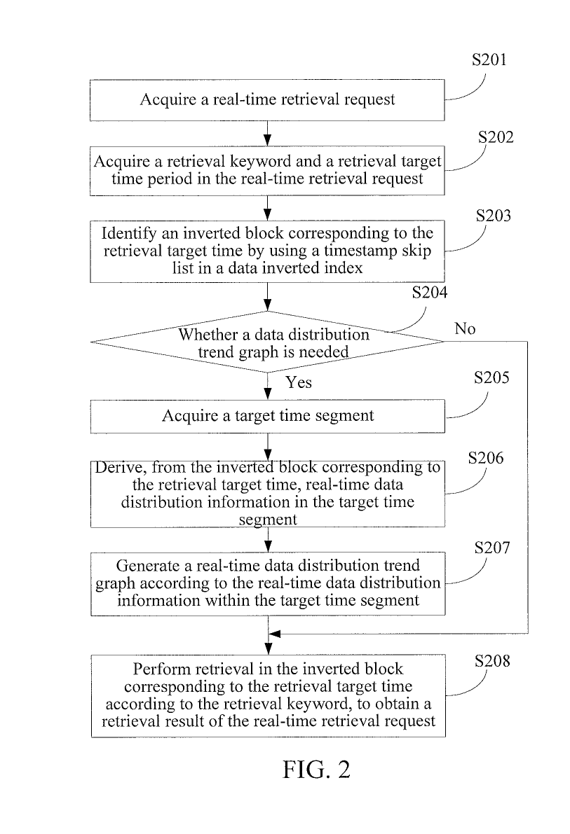

FIG. 2 is a schematic flowchart of a real-time information retrieval method according to a second embodiment of the present application. In the present disclosure, retrieval of articles on Weibo is used as an example to describe an implementation process of real-time information retrieval of the present disclosure in detail.

S201: Acquire a real-time information retrieval request.

Specifically, after logging into a Weibo account by using a terminal such as a mobile phone or a personal computer, a user sends a real-time information retrieval request to a real-time information retrieval apparatus, requesting to retrieve articles in which the user is interested.

S202: Acquire a retrieval keyword and a retrieval target time period in the real-time information retrieval request.

Specifically, the retrieval keyword may be a word input by a user, such as “beauty” or “Porsche”. The retrieval target time period includes a target start time and a target finish time of retrieval. The retrieval target time period may be input by the user or selected by the user from retrieval target time period options provided by the real-time information retrieval apparatus, or may be a default retrieval target time period in the real-time information retrieval apparatus, and indicates that the user wants to search for all data related to the retrieval keyword within this time range.

S203: Identify an inverted real-time data block corresponding to the retrieval target time period by using a timestamp skip list in a data inverted index.

Specifically, the data inverted index in this embodiment of the present application includes a timestamp skip list, and the inverted real-time data block corresponding to the retrieval target time period may be found by using the timestamp skip list in the data inverted index. For example, if the retrieval target time period input by the user is three days ranging from September 21 to September 23, an inverted real-time data block corresponding to September 21 to September 23 may be found by using the timestamp skip list in the data inverted index.

S204: Determine whether a real-time data distribution trend graph is needed.

Specifically, when the user sends the real-time information retrieval request to the real-time information retrieval apparatus, the user may choose to request a data distribution trend graph related to the retrieval keyword at the same time. When acquiring the real-time information retrieval request, the real-time information retrieval apparatus may determine, according to the real-time information retrieval request, whether the user requests a data distribution trend graph. If the user requests a data distribution trend graph, S205 is executed, or otherwise, S208 is executed.

S205: Acquire a target time segment.

Specifically, the target time segment may be a target time segment customized by the user in the real-time information retrieval request, for example, each day of the three days ranging from September 21 to September 23 in the foregoing description is used as a time segment; or, the real-time information retrieval apparatus may automatically acquire a corresponding target time segment according to the retrieval target time period in the real-time information retrieval request, for example, if the retrieval target time period is more than 10 days, each day may be used as a time segment automatically, if the retrieval target time period is less than 10 days but more than 48 hours, half a day may be used as a time segment automatically, and if the retrieval target time period is less than 48 hours, each hour in the retrieval target time period may be used as a time segment automatically.

S206: Derive, from the inverted real-time data block corresponding to the retrieval target time period, real-time data distribution information in the target time segment according to the retrieval keyword and the target time segment.

Specifically, the retrieval may be performed from the inverted real-time data block found in step S203 according to the retrieval keyword to find articles that include the retrieval keyword, and statistical results of the found related data are merged and divided according to the target time segment, thereby obtaining the real-time data distribution information requested by the user. For example, the number of articles including the keyword “beauty” and posted on September 21 is 300,000, the number of articles including the keyword “beauty” and posted on September 22 is 350,000, and the number of articles including the keyword “beauty” and posted on September 24 is 400,000.

S207: Generate a real-time data distribution trend graph according to the real-time data distribution information in the target time segment.

Specifically, for example, a column distribution trend graph may be used to present, to the user, distribution information of the requested keyword in the target time segment.

S208: Perform retrieval in the inverted real-time data block corresponding to the retrieval target time period according to the retrieval keyword, to obtain a retrieval result of the real-time information retrieval request.

Specifically, retrieval may be performed, according to the retrieval keyword, in the inverted real-time data block found in step S102, to find data including the retrieval keyword, and a retrieval result of the real-time information retrieval request is returned to the user. The result may include the found data, or may be a statistical result computed according to the found data. By using retrieval of articles on Weibo as an example, if the user wants to retrieve articles including a keyword “beauty” and posted in the last three days, a list of all articles including “beauty” and posted in the last three days may be returned to the user, and the total number of the articles including “beauty” and posted in the last three days, and the like may further be returned to the user.

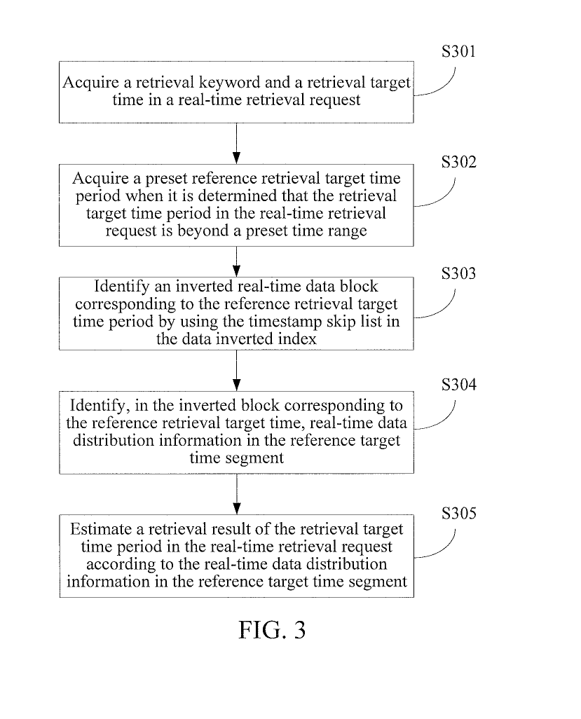

FIG. 3 is a schematic flowchart of a real-time information retrieval method according to a third embodiment of the present application. The real-time information retrieval information acquisition method includes:

S301: Acquire a retrieval keyword and a retrieval target time period in a real-time information retrieval request.

Specifically, the retrieval keyword may be a word input by a user, such as “beauty” or “Porsche”. The retrieval target time period includes a target start time and a target finish time of retrieval. The retrieval target time period may be input by the user or selected by the user from retrieval target time period options provided by a real-time information retrieval apparatus, or may be a default retrieval target time period in the real-time information retrieval apparatus, and indicates that the user wants to search for all data related to the retrieval keyword within this time range.

S302: Acquire a preset reference retrieval target time period and a reference target time segment when it is determined that the retrieval target time period in the real-time information retrieval request is beyond a preset time range.

Specifically, the preset time range may be, for example, 20 days, 30 days, or 60 days. When the retrieval target time period in the real-time information retrieval request sent by the user is beyond the preset time range, the real-time information retrieval apparatus may need to search a large amount of data during the current retrieval, which consumes a large number of computing resources. Therefore, a method in which accurate computation and estimation are combined may be used to acquire a retrieval result requested by the user, where data in the reference retrieval target time period is computed accurately, and real-time data distribution information in the reference retrieval target time period is obtained with reference to the reference target time segment, so that the retrieval result requested by the user in the retrieval target time period may be estimated reliably. The reference retrieval target time period may be last 10 days, 15 days, or 30 days before the real-time information retrieval request submitted by the user is received. Certainly, with a longer selected reference retrieval time, an estimation result is closer to a real result. The reference target time segment may be half a day or a day.

S303: Identify an inverted real-time data block corresponding to the reference retrieval target time period by using the timestamp skip list in the data inverted index.

Specifically, the data inverted index in this embodiment of the present application includes a timestamp skip list, and the inverted real-time data block corresponding to the reference retrieval target time period may be found by using the timestamp skip list in the data inverted index. For example, if the real-time information retrieval request submitted by the user is received on September 20, the reference retrieval target time period may be September 6 to September 20, and an inverted real-time data block corresponding to the 15 days from September 6 to September 20 may be found by using the timestamp skip list in the data inverted index.

S304: Identify, in the inverted real-time data block corresponding to the reference retrieval target time period, real-time data distribution information in the reference target time segment according to the retrieval keyword and the reference target time segment.

Specifically, retrieval may be performed, according to the retrieval keyword, in the inverted real-time data block found in step S303, to find articles that include the retrieval keyword, and statistical results of the found related data are merged and divided according to the target time segment, thereby obtaining the real-time data distribution information in the reference target time segment.

S305: Estimate a retrieval result of the retrieval target time period in the real-time information retrieval request according to the real-time data distribution information in the reference target time segment.

In specific implementation, for example, according to real-time data distribution information in a time segment of every half day in the 15-day reference retrieval target time period, the retrieval result of the retrieval target time period requested by the user may be estimated. Optionally, other time segments not involved in retrieval may further be sampled, for example, the user requests a retrieval result of six months before September 20, and the real-time data distribution information in the 15-day reference target time segment before September 20 is obtained in S304; in this case, each 15-day time segment between March 20 and September 5 may be sampled, and data in six months before September 20 is estimated with reference to the real-time data distribution information in the reference target time segment and the obtained retrieval data of each 15 days sampled, thereby solving an issue of the balance between the accuracy of the trend and the large consumption of computing resources. In other embodiments, retrieval results of some of hierarchical databases may further be sampled, so that retrieval results of all hierarchical databases at a same level may be estimated, for example, if the user requests to retrieve articles including a keyword “beauty” and posted in the last ten days, and a real-time information retrieval server includes ten small cycle units, in this case, normal retrieval may be performed in one to three small cycle units among the ten small cycle units, and obtained sample data is used for estimating data of all the ten small cycle units.

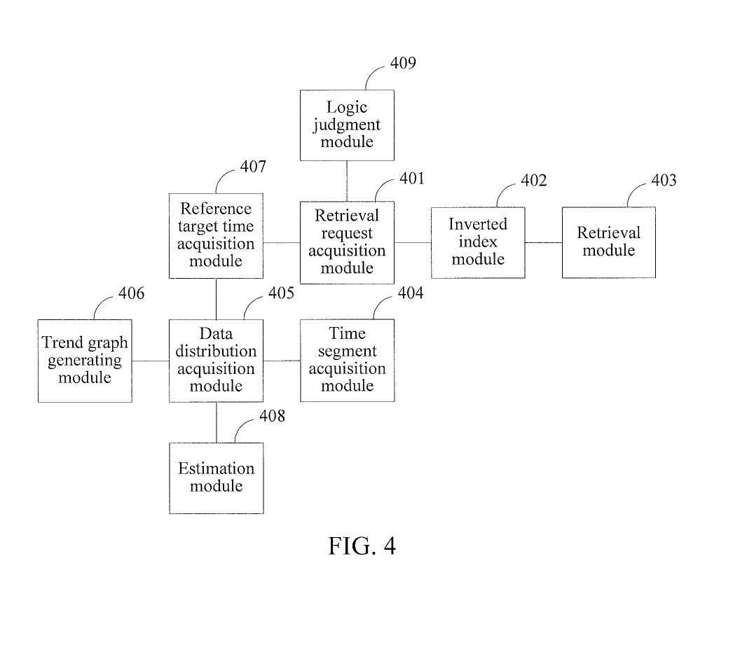

FIG. 4 is a schematic structural diagram of a real-time information retrieval apparatus according to an embodiment of the present application. The real-time information retrieval apparatus at least includes a processor, memory and a program module group stored in the memory and executed by the processor, the program module group further including a retrieval request acquisition module 401, an inverted index module 402, and a retrieval module 403.

The retrieval request acquisition module 401 acquires a retrieval keyword and a retrieval target time period in a real-time information retrieval request.

Specifically, the retrieval keyword may be a word input by a user, such as “beauty” or “Porsche”. The retrieval target time period includes a target start time and a target finish time of retrieval. The retrieval target time period may be input by the user or selected by the user from retrieval target time period options provided by the real-time information retrieval apparatus, or may be a default retrieval target time period in the real-time information retrieval apparatus, and indicates that the user wants to search for all data related to the retrieval keyword within this time range.

The inverted index module 402 identifies, among a plurality of inverted real-time data blocks, an inverted real-time data block corresponding to the retrieval target time period by using a timestamp skip list in a data inverted index associated with the plurality of inverted real-time data blocks.

Specifically, the data inverted index in this embodiment of the present application includes a timestamp skip list, and the inverted real-time data block corresponding to the retrieval target time period may be found by using the timestamp skip list in the data inverted index. For example, if the retrieval target time period input by the user is three days ranging from September 21 to September 23, an inverted real-time data block corresponding to September 21 to September 23 may be found by using the timestamp skip list in the data inverted index. In some embodiments, the inverted index module 402 may include a hierarchical database matching unit and an inverted real-time data block acquisition unit.

The hierarchical database matching unit matches the retrieval target time period with a corresponding hierarchical database by using the timestamp skip list in the data inverted index, where the hierarchical database includes multiple databases for separately storing inverted real-time data blocks in different time periods. For example, the hierarchical database may include a miniature cycle unit for storing data in the last 3 days; a small cycle unit for storing data from 3 days ago to 10 days ago, a medium cycle unit for storing data from 10 days ago to 30 days ago; and a large cycle unit for storing data before 30 days ago. The hierarchical database matching unit may find the corresponding hierarchical database by using the timestamp skip list in the data inverted index according to the retrieval target time period.

The inverted real-time data block acquisition unit acquires, in the hierarchical database corresponding to the retrieval target time period, the inverted real-time data block corresponding to the retrieval target time period. For example, if the retrieval target time period in the request of the user is the last 8 days, the hierarchical database matching the retrieval target time period may include the miniature cycle unit and the small cycle unit. Further, the inverted real-time data block acquisition unit may directly search for the inverted real-time data block corresponding to the retrieval target time period in the two relatively small hierarchical databases, so as to avoid search in a hierarchical database with a huge amount of data, thereby saving a lot of system resources. The retrieval module 403 performs retrieval in the inverted real-time data block corresponding to the retrieval target time period according to the retrieval keyword, to obtain a retrieval result of the real-time information retrieval request.

Specifically, the retrieval module 403 may perform, according to the retrieval keyword, retrieval in the inverted real-time data block found by the inverted index module 402, search for data including the retrieval keyword, and return a retrieval result of the real-time information retrieval request to the user. The result may include the found data, or may be a statistical result computed according to the found data. By using retrieval of articles on Weibo as an example, if the user wants to retrieve articles including a keyword “beauty” and posted in the last three days, a list of all articles including “beauty” and posted in the last three days may be returned to the user, and the total number of the articles including “beauty” and posted in the last three days, and the like may further be returned to the user.

Further, the real-time information retrieval apparatus may optionally include a time segment acquisition module 404, a data distribution acquisition module 405, and a trend graph generating module 406.

The time segment acquisition module 404 is configured to identify a target time segment according to the real-time information retrieval request.

Specifically, when the real-time information retrieval request submitted by the user to the real-time information retrieval apparatus includes a request for a data distribution trend graph, the time segment acquisition module 404 may acquire the target time segment according to the request of the user. The target time segment may be a target time segment customized by the user in the real-time information retrieval request, for example, each day of the three days ranging from September 21 to September 23 in the above description is used as a time segment; or, the target time segment may be a corresponding target time segment acquired by the real-time information retrieval apparatus according to the retrieval target time period in the real-time information retrieval request, for example, if the retrieval target time period is more than 10 days, each day may be used as a time segment automatically, if the retrieval target time period is less than 10 days but more than 48 hours, half a day may be used as a time segment automatically, and if the retrieval target time period is less than 48 hours, each hour in the retrieval target time period may be used as a time segment automatically.

The data distribution acquisition module 405 acquires, in the inverted real-time data block corresponding to the retrieval target time period, real-time data distribution information in the target time segment according to the retrieval keyword and the target time segment.

Specifically, retrieval may be performed, according to the retrieval keyword, in the inverted real-time data block found by the inverted index module 402, to find articles that include the retrieval keyword, and statistical results of the found related data are merged and divided according to the target time segment, thereby obtaining the real-time data distribution information requested by the user, for example, the number of articles including the keyword “beauty” and posted on September 21 is 300,000, the number of articles including the keyword “beauty” and posted on September 22 is 350,000, and the number of articles including the keyword “beauty” and posted on September 24 is 400,000.

The trend graph generating module 406 generates a data distribution trend graph according to the real-time data distribution information in the target time segment.

Specifically, for example, a column distribution trend graph may be used to present, to the user, distribution information of the requested keyword in the target time segment.

Further, the real-time information retrieval apparatus may optionally include a reference target time acquisition module 407 and an estimation module 408.

The reference target time acquisition module 407 acquires a reference retrieval target time period and a reference target time segment when the retrieval target time period in the real-time information retrieval request is beyond a preset time range.

Specifically, the preset time range may be, for example, 20 days, 30 days, or 60 days. When the retrieval target time period in the real-time information retrieval request sent by the user is beyond the preset time range, the real-time information retrieval apparatus may need to search a large amount of data during the current retrieval, which consumes a large number of computing resources. Therefore, a method in which accurate computation and estimation are combined may be used to acquire a retrieval result requested by the user, where data in the reference retrieval target time period is computed accurately, and real-time data distribution information in the reference retrieval target time period is obtained with reference to the reference target time segment, so that the retrieval result requested by the user in the retrieval target time period may be estimated reliably. The reference retrieval target time period may be last 10 days, 15 days, or 30 days before the real-time information retrieval request submitted by the user is received. Certainly, with a longer selected reference retrieval time, an estimation result is closer to a real result. The reference target time segment may be half a day or a day.

The inverted index module 402 further acquires an inverted real-time data block corresponding to the reference retrieval target time period by using the timestamp skip list in the data inverted index. The data distribution acquisition module 405 further acquires, in the inverted real-time data block corresponding to the reference retrieval target time period, real-time data distribution information in the reference target time segment according to the retrieval keyword and the reference target time segment.

The estimation module 408 estimates a retrieval result of the retrieval target time period in the real-time information retrieval request according to the real-time data distribution information in the reference target time segment.

In specific implementation, for example, according to real-time data distribution information in a time segment of every half day in the 15-day reference retrieval target time period, the estimation module 408 estimates the retrieval result of the retrieval target time period requested by the user. Optionally, the estimation module 408 may further sample other time segments not involved in retrieval, for example, the user requests a retrieval result of six months before September 20, and the real-time data distribution information in the 15-day reference target time segment before September 20 is obtained in S304; in this case, each 15-day time segment between March 20 and September 5 may be sampled, and data in six months before September 20 is estimated with reference to the real-time data distribution information in the reference target time segment and the obtained retrieval data of each 15 days sampled, thereby solving an issue of the balance between the accuracy of the trend and the large consumption of computing resources. In other embodiments, retrieval results of some of hierarchical databases may further be sampled, so that retrieval results of all hierarchical databases at a same level may be estimated, for example, if the user requests to retrieve articles including a keyword “beauty” and posted in the last ten days, and a real-time information retrieval server includes ten small cycle units, in this case, normal retrieval may be performed in one to three small cycle units among the ten small cycle units, and obtained sample data is used for estimating data of all the ten small cycle units.

Further, optionally, the real-time information retrieval apparatus may further include a logic judgment module 409.

The logic judgment module 409 determines whether the retrieval keyword in the real-time information retrieval request is an invalid keyword according to a preset logic judgment rule. Situations of determining that the retrieval keyword is an invalid keyword includes, but is not limited to the following:

1. a Chinese keyword longer than 20 Bytes or shorter than 4 Bytes;

2. other combined Chinese and non-Chinese keywords longer than 20 Bytes or shorter than 2 Bytes;

3. a keyword including a security sensitive word (for example, a pornographic or politically sensitive word); and

4. a keyword only including an ultra-high frequency word (such as “of” or “is”).

When it is determined that the retrieval keyword is an invalid keyword, a specific result may be returned to the user, for example, “something is wrong with the input keyword”, “the input keyword includes a sensitive word”, or “the keyword is invalid”; or if it is determined that the retrieval keyword is not an invalid keyword, the retrieval request acquisition module 401 is instructed to acquire the retrieval keyword and the retrieval target time period in the real-time information retrieval request.

All the foregoing modules are stored in memory, so as to be executed by a processor.

An embodiment of the present application further provides a real-time information retrieval server, including the real-time information retrieval apparatus described above with reference to FIG. 4.

In the embodiments of the present application, by using a newly added timestamp skip list in a data inverted index, an inverted real-time data block corresponding to a retrieval target time period can be found quickly, so that fast real-time data retrieval can be implemented, and further, a data distribution trend graph can be acquired in real time with reduced costs.

When the real-time information retrieval method is implemented in a form of software function modules and sold or used as an independent product, the method may also be stored in a non-transitory computer readable storage medium for execution by one or more processors of a computer server. A person of ordinary skill in the art may understand that all or some of the processes in the methods of the foregoing embodiments may be implemented by a computer program instructing relevant hardware. The program may be stored in a non-transitory computer readable storage medium. When executed by the processor, the program may include processes of the embodiments of all the foregoing methods. The storage medium may be a magnetic disk, an optical disc, a read-only memory (ROM), a random access memory (RAM), or the like.

The foregoing descriptions are merely preferred embodiments of the present application, and certainly, the scope of the claims of the present disclosure is not limited thereto. Therefore, any equivalent change made according to the claims of the present disclosure shall fall within the scope of the present disclosure.

What is claimed is:

1. A real-time information retrieval method, comprising:
at a computer server having one or more processors and memory for storing programs to be executed by the one or more processors:
acquiring a retrieval keyword and a retrieval target time period in a real-time information retrieval request submitted by an end user from a terminal;
identifying, among a plurality of inverted real-time data blocks, an inverted real-time data block corresponding to the retrieval target time period by using a timestamp skip list in a data inverted index associated with the plurality of inverted real-time data blocks;
retrieving information from the inverted real-time data block corresponding to the retrieval target time period according to the retrieval keyword, to obtain a retrieval result of the real-time information retrieval request; and
returning the retrieval result of the real-time information retrieval request to the requesting terminal.

2. The real-time information retrieval method according to claim 1, further comprising:
identifying a target time segment according to the real-time information retrieval request;
deriving real-time data distribution information from the inverted real-time data block corresponding to the retrieval target time period, the data distribution information matching the retrieval keyword and the target time segment;
generating a real-time data distribution trend graph according to the real-time data distribution information within the target time segment; and
returning the real-time data distribution trend graph to the requesting terminal.

3. The real-time information retrieval method according to claim 1, further comprising:
acquiring a preset reference retrieval target time period and a reference target time segment when it is determined that the retrieval target time period in the real-time information retrieval request is beyond a preset time range;
identifying, among the plurality of inverted real-time data blocks, an inverted real-time data block corresponding to the reference retrieval target time period by using the timestamp skip list in the data inverted index;
acquiring, in the inverted real-time data block corresponding to the reference retrieval target time period, real-time data distribution information in the reference target time segment according to the retrieval keyword and the reference target time segment; and
estimating a retrieval result of the retrieval target time period in the real-time information retrieval request according to the real-time data distribution information in the reference target time segment.

4. The real-time information retrieval method according to claim 1, wherein the step of identifying an inverted real-time data block corresponding to the retrieval target time period by using a timestamp skip list in a data inverted index comprises:
matching the retrieval target time period with a corresponding hierarchical database by using the timestamp skip list in the data inverted index, the hierarchical database comprising multiple databases for separately storing inverted real-time data blocks in different time periods; and
identifying, in the hierarchical database corresponding to the retrieval target time period, the inverted real-time data block corresponding to the retrieval target time period.

5. The real-time information retrieval method according to claim 1, before the step of acquiring a retrieval keyword and a retrieval target time period in a real-time information retrieval request, the method further comprising:
determining whether the retrieval keyword in the real-time information retrieval request is an invalid keyword according to a preset logic judgment rule; and
acquiring the retrieval keyword and the retrieval target time period in the real-time information retrieval request if it is determined that the retrieval keyword is not an invalid keyword.

6. A real-time information retrieval apparatus, comprising:
a processor;
memory; and
a program module group stored in the memory and executed by the processor, and the program module group further comprising:
a retrieval request acquisition module, configured to a retrieval keyword and a retrieval target time period in a real-time information retrieval request submitted by an end user from a terminal;
an inverted index module, configured to identify, among a plurality of inverted real-time data blocks, an inverted real-time data block corresponding to the retrieval target time period by using a timestamp skip list in a data inverted index associated with the plurality of inverted real-time data blocks; and
a retrieval module, configured to retrieve information from the inverted real-time data block corresponding to the retrieval target time period according to the retrieval keyword, to obtain a retrieval result of the real-time information retrieval request and return the retrieval result of the real-time information retrieval request to the requesting terminal.

7. The real-time information retrieval apparatus according to claim 6, wherein the program module group further comprises:
a time segment acquisition module, configured to identify a target time segment according to the real-time information retrieval request;
a data distribution acquisition module, configured to derive real-time data distribution information from the inverted real-time data block corresponding to the retrieval target time period, the data distribution information matching the retrieval keyword and the target time segment; and
a trend graph generating module, configured to generate a real-time data distribution trend graph according to the real-time data distribution information within the target time segment and return the real-time data distribution trend graph to the requesting terminal.

8. The real-time information retrieval apparatus according to claim 6, wherein the program module group further comprises:
a reference target time acquisition module, configured to acquire a reference retrieval target time period and a reference target time segment when it is determined that the retrieval target time period in the real-time information retrieval request is beyond a preset time range, wherein the inverted index module is further configured to identify, among the plurality of inverted real-time data blocks, an inverted real-time data block corresponding to the reference retrieval target time period by using the timestamp skip list in the data inverted index, and the data distribution acquisition module is further configured to acquire, in the inverted real-time data block corresponding to the reference retrieval target time period, real-time data distribution information in the reference target time segment according to the retrieval keyword and the reference target time segment; and
an estimation module, configured to estimate a retrieval result of the retrieval target time period in the real-time information retrieval request according to the real-time data distribution information in the reference target time segment.

9. The real-time information retrieval apparatus according to claim 6, wherein the inverted index module further comprises:
a hierarchical database matching unit, configured to match the retrieval target time period with a corresponding hierarchical database by using the timestamp skip list in the data inverted index, the hierarchical database comprising multiple databases for separately storing inverted real-time data blocks in different time periods; and
an inverted real-time data block acquisition unit, configured to acquire, in the hierarchical database corresponding to the retrieval target time period, the inverted real-time data block corresponding to the retrieval target time period.

10. The real-time information retrieval apparatus according to claim 6, wherein the program module group further comprises:
a logic judgment module, configured to determine whether the retrieval keyword in the real-time information retrieval request is an invalid keyword according to a preset logic judgment rule; and
acquire the retrieval keyword and the retrieval target time period in the real-time information retrieval request if it is determined that the retrieval keyword is not an invalid keyword.

11. A non-transitory computer readable storage medium storing a program module group for execution by one or more processors of a computer server having memory for storing programs to be executed by the one or more processors, the program module group further including:
a retrieval request acquisition module, configured to a retrieval keyword and a retrieval target time period in a real-time information retrieval request submitted by an end user from a terminal;
an inverted index module, configured to identify, among a plurality of inverted real-time data blocks, an inverted real-time data block corresponding to the retrieval target time period by using a timestamp skip list in a data inverted index associated with the plurality of inverted real-time data blocks; and
a retrieval module, configured to retrieve information from the inverted real-time data block corresponding to the retrieval target time period according to the retrieval keyword, to obtain a retrieval result of the real-time information retrieval request and return the retrieval result of the real-time information retrieval request to the requesting terminal.

12. The non-transitory computer readable storage medium according to claim 11, wherein the program module group further comprises:
a time segment acquisition module, configured to identify a target time segment according to the real-time information retrieval request;
a data distribution acquisition module, configured to derive real-time data distribution information from the inverted real-time data block corresponding to the retrieval target time period, the data distribution information matching the retrieval keyword and the target time segment; and
a trend graph generating module, configured to generate a real-time data distribution trend graph according to the real-time data distribution information within the target time segment and return the real-time data distribution trend graph to the requesting terminal.

13. The non-transitory computer readable storage medium according to claim 11, wherein the program module group further comprises:
a reference target time acquisition module, configured to acquire a reference retrieval target time period and a reference target time segment when it is determined that the retrieval target time period in the real-time information retrieval request is beyond a preset time range, wherein the inverted index module is further configured to identify, among the plurality of inverted real-time data blocks, an inverted real-time data block corresponding to the reference retrieval target time period by using the timestamp skip list in the data inverted index, and the data distribution acquisition module is further configured to acquire, in the inverted real-time data block corresponding to the reference retrieval target time period, real-time data distribution information in the reference target time segment according to the retrieval keyword and the reference target time segment; and
an estimation module, configured to estimate a retrieval result of the retrieval target time period in the real-time information retrieval request according to the real-time data distribution information in the reference target time segment.

14. The non-transitory computer readable storage medium according to claim 11, wherein the inverted index module further comprises:
a hierarchical database matching unit, configured to match the retrieval target time period with a corresponding hierarchical database by using the timestamp skip list in the data inverted index, the hierarchical database comprising multiple databases for separately storing inverted real-time data blocks in different time periods; and
an inverted real-time data block acquisition unit, configured to acquire, in the hierarchical database corresponding to the retrieval target time period, the inverted real-time data block corresponding to the retrieval target time period.

15. The non-transitory computer readable storage medium according to claim 11, wherein the program module group further comprises:
a logic judgment module, configured to determine whether the retrieval keyword in the real-time information retrieval request is an invalid keyword according to a preset logic judgment rule; and
acquire the retrieval keyword and the retrieval target time period in the real-time information retrieval request if it is determined that the retrieval keyword is not an invalid keyword.
